(19) United States
(12) Patent Application Publication
(10) Pub. No.: US 2002/0033840 A1
(43) Pub. Date: Mar. 21, 2002

(54) Graphical user interface

(75) Inventors: Judith F.M. Masthoff, Brighton (GB); Susan Coles, Nuenen (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/954,648

(22) Filed: Sep. 18, 2001

(30) Foreign Application Priority Data
Sep. 20, 2000 (GB) 0023004.5

(51) Int. Cl. G09G 5/00

(52) U.S. Cl. 345/700

(57) ABSTRACT

A graphical user interface (12, 32) displaying parameters for selection is customisable by a habit or pattern sensing device (22, 38) which provides a display in an optimised format. The user presses a button (20, 50) once to accept the optimised interface and twice to return to a default setting. The parameters may be television channels, or may be variables in an image processing system.

This invention relates to a method for providing, and an apparatus hosting, an improved Graphical User Interface (GUI), especially such a GUI which is variable in accordance with user requirements.

In U.S. Pat. No. 5,760,768 (Microsoft Corporation), a system is disclosed which can be customised by allowing the user to define keystroke sequences to execute any desired menu command, and by allowing the user to associate any menu command with a desired menu displayed. However, the user must explicitly tell the system what is required, and many users do not like to put in the effort required to achieve a desired customisation.

Sometimes a change is made automatically. Users of Microsoft “Word” word-processing packages find that if a year such as “2000” is typed in a document, the software automatically adds the month and year of the day's date in U.S. format, as in 2000-03-03. Many users find this irritating, even if they require today's date at this position in the text, which is not necessarily the case.

In another Microsoft product, “Office 2000”, menus and toolbars are personalised as the software learns the personal work patterns of the user; a small number of the most frequently used icons are displayed, while unused or infrequently used icons are hidden, so menus and toolbars are simplified. Again, the user is given is no choice, although a control menu option allows all menu option icons to be again called to the display.

In some systems in which a GUI is changed automatically, the user is provided with an “Undo” button, but this is not always easy to find and, in addition, a user may not notice a small change, which may be incorrect or not what the user prefers.

In European Patent application EP-A-0 562 995 (IBM), a graphical end-user interface for intelligent assistants is disclosed. An assistant is arranged to offer suggestions to a user, the suggestions being standard options available in the software. For example, if a user opens an In-basket to read incoming e-mail, and finds a letter there, the assistant “reviews” the content of the letter and, by observing the user's past actions, records which actions of a standard set of actions a user may perform. The assistant then offers the standard options, such as telephoning the sender of the letter and/or of printing out the letter. The user may then decide by clicking on the respective option icon to select one of the options. However, the system then reverts to the normal display.

An object of the present invention is to provide a method of customising a GUI which avoids the limitations and irritations of the prior art.

In accordance with the present invention there is provided a method of customising a graphical user interface for a computer controlled system having at least one selectable parameter comprising the steps of:

monitoring the selection of the at least one selectable parameter by a user;

determining any pattern of selection;

devising an optimised arrangement of the parameter selection which matches the pattern of selection;

displaying the optimised arrangement; and

providing actuatable means arranged so that a first actuation accepts the displayed optimised arrangement and a second activation cancels the displayed optimised arrangement.

Further features are recited in the attached claims, to which the user is now directed and the disclosures of which are incorporated herein by reference.

The invention will be described by way of example only with reference to the accompanying drawings in which:

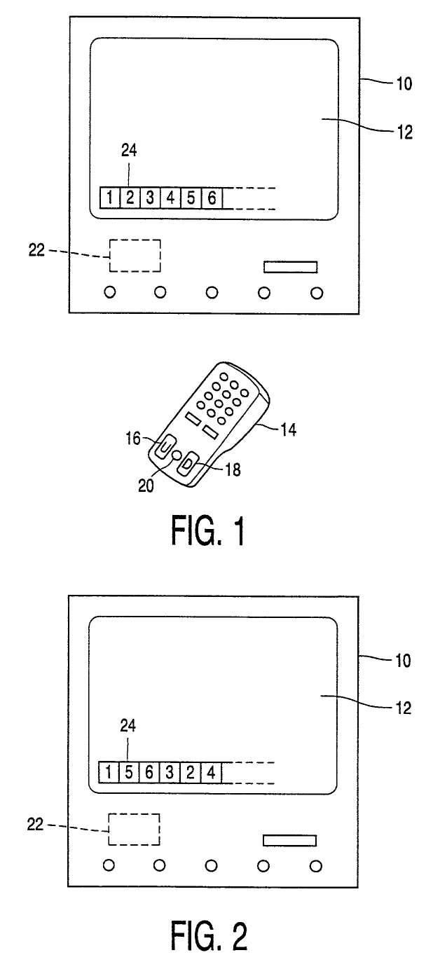

FIGS. 1 and 2 illustrate the application of the invention to a television display; and

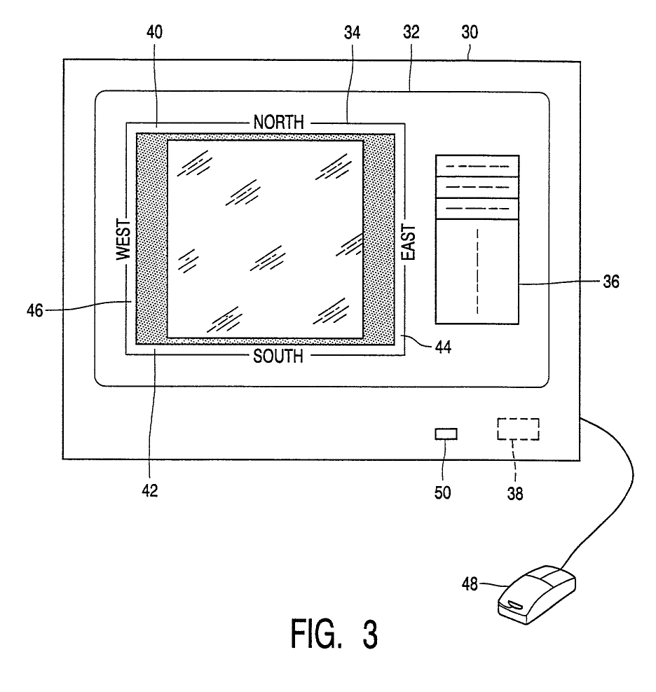

FIG. 3 illustrates application of the invention to an X-ray viewing and post processing system.

FIG. 1 illustrates a television set 10 having a screen 12, the set being operable by a remote control 14 operating by conventional means such as signals at infrared frequencies. The remote control has the usual buttons “Up” and “Down” 16, 18 and a third button “Optimise” 20. The television contains an additional circuit 22, shown dotted, which records patterns of channel selection.

When a viewer of the television wishes to change channels, one of the buttons Up or Down is pressed and a display 24 is then provided on the screen, showing the channels in numerical order. To change from a current channel such as channel 1 to a desired channel such as channel 5, the user must scan through every intermediate channel, pressing the Up button each time. With a large number of channels and a large difference of channel number, this can be tedious.

After a period of use, the circuit 22 detects patterns of use, for example that the viewer watches channels 1 and 5 most frequently. The next time that the viewer, while watching channel 1, presses the Up button, the circuit 22 causes the display 24 to be in optimised form, as shown in FIG. 2. Channel 5 is now adjacent to channel 1 on the display.

The Optimise button 20 now comes into use. If the viewer approves of the optimisation, the button 20 is pressed once, and the optimised display 24 of FIG. 2 will always be provided in future. If the viewer does not like the optimisation, pressing the Optimise button 20 twice cancels the optimisation and the channel order of FIG. 1 is reinstated.

FIG. 3 shows an x-ray record viewing device 30 having a screen 32 on which an x-ray image 34 is displayed for image processing. The image is bounded by four shutters 40, 42, 44, 46 labelled also North, South, East, and West, and the screen 32 also displays a menu 36. The viewing device 30 contains a viewing habit sensing device 38, shown dotted, and also has a mouse 48.

As is known, the x-ray image 34 can be processed by moving the shutters 40, 42, 44, 46 to define a selected area of the image; the brightness and contrast of the image 34 can be varied, and there is an image enhancement function also. Zoom in the x and y directions can be controlled. All of these options are displayed in list form in the menu 36, for example as:

Brightness

Contrast

Enhancement

Zoom X

Zoom Y

North shutter

South shutter

East shutter

West shutter

Suppose that a long series of similar x-ray images is being viewed. The viewing habit sensing device 38 may sense that, for each image the contrast is varied, but brightness and enhancement are left at the default settings of the device 30. Also, the shutters are moved, but the zoom features are not used. The device 30 will then present an optimised menu 36 in the order

Contrast

North shutter

South shutter

East shutter

West shutter

Brightness

Enhancement

Zoom X

Zoom Y

The most frequently used variables are now presented more conveniently for the user to select by use of the mouse. If the user approves the new menu order, the optimisation button 50 is pressed once; if the user does not approve, or is about to begin to process a different series of x-ray images which may require different processing treatment, the user presses the button 50 twice and the menu 36 is returned to its original order. Instead of a separate optimisation button 50, there may be an area of the menu 36 operable by the mouse to accept or reject the optimisation.

While the habit monitoring circuits have been illustrated as separate circuits 22, 38, it is in practice likely that this feature will be a software feature of the computer processing device or chip controlling the overall system, and such a variation is encompassed in the claims hereinafter.

In the medical field, in addition to optimising the processing of x-ray images, the principle of the invention can also be applied to making the x-ray image in the first place, i.e. in setting up the x-ray imaging system when a repetitive series of x-rays is to be taken.

1. A method of customising a graphical user interface for a computer controlled system having at least one selectable parameter, comprising the steps of:
monitoring the selection of the at least one selectable parameter by a user;
determining any pattern of selection;
devising an optimised arrangement of the parameter selection which matches the pattern of selection;
displaying the optimised arrangement; and
providing actuatable means arranged so that a first actuation accepts the displayed optimised arrangement and a second activation cancels the displayed optimised arrangement.

2. A method according to claim 1, in which the parameters are displayed as a menu and the order of the parameters in the menu is varied.

3. A method according to claim 1, in which the selectable parameters are channels of a multi-channel television system.

4. A method according to claim 1, in which the selectable parameters are processing parameters of an optical processing system.

5. A method according to claim 4, in which the optical system is an x-ray image processing system.

6. A method according to claim 4, in which the optical system is an x-ray image recording system.

7. A computer controlled system having a customisable graphical user interface by which a plurality of parameters can be selected comprising:
display means to display the parameters;
selection means to select the parameters;
monitoring means to monitor the selection of parameters and to devise an optimised arrangement of the parameter selection, and
actuatable means arranged so that a first actuation accepts the displayed optimised arrangement and a second actuation cancels the displayed optimised arrangement.

8. A system according to claim 7, in which the actuable means is a manual control.
